(19) United States
(12) Patent Application Publication
(10) Pub. No.: US 2017/0093465 A1
(43) Pub. Date: Mar. 30, 2017

(54) System and Method for Large Scale Multiple Input Multiple Output Communications

(71) Applicant: Futurewei Technologies, Inc., Plano, TX (US)

(72) Inventors: Arkady Molev Shteiman, Bridgewater, NJ (US); Xiao Feng Qi, Westfield, NJ (US)

(21) Appl. No.: 14/867,931

(22) Filed: Sep. 28, 2015

(51) Int. Cl. H04B 7/04

(52) U.S. Cl. CPC H04B 7/0413

(57) ABSTRACT

A large scale multiple input multiple output (MIMO) communications device includes a first plurality of antenna units (AUs) arranged in an array, and a central processing unit operatively coupled to a first end AU in the first plurality of AUs. Each AU in the first plurality of AUs is operatively coupled to at least two neighboring AUs, and wherein each AU receives wireless signals, receives neighbor information from at least a first neighboring AU, generates local information associated with the AU in accordance with the received wireless signals and the neighbor information, and sends the local information associated with the AU to a second neighboring AU. The central processing unit receives local information associated with the first end AU, and generates estimates of the received transmissions in accordance with the local information associated with the first end AU.

### TECHNICAL FIELD

The present disclosure relates generally to digital communications, and more particularly to a system and method for large scale multiple input multiple output (MIMO) communications.

### BACKGROUND

In general, multiple input multiple output (MIMO) increases the capacity of a radio link through the use of multiple transmit antennas and multiple receive antennas. MIMO exploits multipath propagation to increase the capacity of the radio link. MIMO has proven to be effective at increasing the capacity of the radio link and has been accepted into a variety of technical standards, including WiFi or Wireless LAN: IEEE 802.11n, and IEEE 802.11ac; Evolved High-Speed Packet Access (HSPA+); Worldwide Interoperability for Microwave Access (WiMAX); and Third Generation Partnership Project (3GPP) Long Term Evolution (LTE) Advanced.

Increasing the number of transmit antennas and receive antennas from a relatively small number (on the order of 10 or fewer) to a significantly larger number (on the order of 100, 1000, 10000, or more) can lead to even greater increases in the capacity of the radio link. However, dramatically increasing the number of transmit antennas and receive antennas also greatly increases the computational complexity involved in signal processing, as well as the amount of data exchanged between the antennas and a processing unit supporting MIMO communications. Therefore, there is a need for systems and methods for supporting large scale MIMO communications.

### SUMMARY OF THE DISCLOSURE

Example embodiments provide a system and method for large scale multiple input multiple output (MIMO) communications.

In accordance with an example embodiment, a large scale multiple input multiple output (MIMO) communications device adapted to receive transmissions is provided. The large scale MIMO communications device includes a first plurality of antenna units (AUs) arranged in an array, and a central processing unit operatively coupled to a first end AU in the first plurality of AUs. Each AU in the first plurality of AUs is operatively coupled to at least two neighboring AUs. Each AU receives wireless signals, receives neighbor information from at least a first neighboring AU, generates local information associated with the AU in accordance with the received wireless signals and the neighbor information, and sends the local information associated with the AU to a second neighboring AU. The central processing unit receives local information associated with the first end AU, and generates estimates of the received transmissions in accordance with the local information associated with the first end AU.

In accordance with another example embodiment, a large scale multiple input multiple output (MIMO) communications device adapted to send transmissions is provided. The large scale MIMO communications device includes a central processing unit, and a first plurality of antenna units (AU) arranged in an array. The first plurality of AUs is operatively coupled to the central processing unit, and each AU in the first plurality of AUs is operatively coupled to at least two neighboring AUs and includes an AU processing unit. Each AU receives local information associated with the AU from the central processing unit, and generates data in accordance with the local information associated with the AU.

In accordance with another example embodiment, a method for operating a large scale multiple input multiple output (MIMO) communications device is provided. The method includes measuring received energy levels in portions of a search space using antenna beams generated by independent antenna arrays partitioned from an antenna array, where each independent antenna array is assigned to at least one portion of the search space, and selecting received energy levels meeting a specified threshold. The method includes communicating using antenna beams generated by the antenna array, where the antenna beams are associated with the selected received energy levels.

In accordance with another example embodiment, a large scale multiple input multiple output (MIMO) communications device is provided. The large scale MIMO communications device includes an antenna array, a processor operatively coupled to the antenna array, and a computer readable storage medium storing programming for execution by the processor. The programming including instructions configuring the large scale MIMO communications device to measure received energy levels in portions of a search space using antenna beams generated by independent antenna arrays partitioned from the antenna array, where each independent antenna array is assigned to at least one portion of the search space, select received energy levels meeting a specified threshold, and communicate using antenna beams generated by the antenna array, where the antenna beams are associated with the selected received energy levels.

Practice of the foregoing embodiments enable large scale MIMO communications with reduced computational overhead at a processing unit supporting MIMO communications and data exchanged between the antennas and the processing unit.

Moreover, the embodiments provide for a system and method for fast acquisition of beams in a large scale MIMO communications system.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system highlighting MIMO reception according to example embodiments described herein;

FIG. 2A illustrates a chain of AUs configured to determine a MRC vector R in a distributed computing manner according to example embodiments described herein;

FIG. 2B illustrates an example MR combiner of an AU according to example embodiments described herein;

FIG. 3 illustrates a chain of AUs configured to determine an autocorrelation matrix Acor in a distributed manner according to example embodiments described herein;

FIG. 4 illustrates an example communications system highlighting MIMO transmission according to example embodiments described herein;

FIG. 5A illustrates a chain of AUs configured to perform MIMO precoding in a distributed computing manner according to example embodiments described herein;

FIG. 5B illustrates an example channel matching unit of an AU according to example embodiments described herein;

FIG. 6A illustrates a chain of AUs configured to determine channel estimates in a distributed computing manner according to example embodiments described herein;

FIG. 6B illustrates an example antenna channel estimation unit according to example embodiments described herein;

FIG. 7 illustrates a first example MIMO communications device, highlighting the architecture of MIMO communications device according to example embodiments described herein;

FIG. 8 illustrates a detailed view of a second example MIMO communications device, highlighting interconnections between components of MIMO communications device according to example embodiments described herein;

FIG. 9 illustrates a detailed view of an example AU according to example embodiments described herein;

FIG. 10A illustrates a second example MIMO communications device, highlighting the architecture of MIMO communications device according to example embodiments described herein;

FIG. 10B illustrates a third example MIMO communications device, highlighting the architecture of MIMO communications device according to example embodiments described herein;

FIG. 11 illustrates an example MIMO communications device, highlighting distributed arrays of AUs according to example embodiments described herein;

FIG. 12A illustrates a one-dimensional massive MIMO antenna according to example embodiments described herein;

FIG. 12B illustrates a two-dimensional massive MIMO antenna according to example embodiments described herein;

FIG. 13 illustrates a plurality of antenna beams according to example embodiments described herein;

FIG. 14 illustrates the architecture of a portion of an example massive MIMO multi-beam receiver according to example embodiments described herein;

FIG. 15 illustrates a flow diagram of example operations occurring in a fast determining of antenna beams for a massive MIMO communications device according to example embodiments described herein;

FIG. 16 illustrates an example massive MIMO communications device, highlighting a partitioned antenna array according to example embodiments described herein;

FIG. 17 illustrates an example combining circuit according to example embodiments described herein;

FIG. 18 illustrates a block diagram of an embodiment processing system for performing methods described herein according to example embodiments described herein; and

FIG. 19 illustrates a block diagram of a transceiver adapted to transmit and receive signaling over a telecommunications network according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the embodiments and ways to operate the embodiments disclosed herein, and do not limit the scope of the disclosure.

One embodiment relates to large scale multiple input multiple output (MIMO) communications. For example, a large scale multiple input multiple output (MIMO) communications device includes a first plurality of antenna units (AUs) arranged in an array, and a central processing unit operatively coupled to a first end AU in the first plurality of AUs. Each AU in the first plurality of AUs is operatively coupled to at least two neighboring AUs, and wherein each AU receives wireless signals, receives neighbor information from at least a first neighboring AU, generates local information associated with the AU in accordance with the received wireless signals and the neighbor information, and sends the local information associated with the AU to a second neighboring AU. The central processing unit receives local information associated with the first end AU, and generates estimates of the received transmissions in accordance with the local information associated with the first end AU.

The embodiments will be described with respect to example embodiments in a specific context, namely MIMO communications systems that support very large numbers of transmit antennas and receive antennas. The embodiments may be applied to standards compliant FD communications systems, such as those that are compliant with Third Generation Partnership Project (3GPP), IEEE 802.11, WiMAX, HSPA, and the like, technical standards, and non-standards compliant MIMO communications systems, that support very large numbers of transmit antennas and receive antennas.

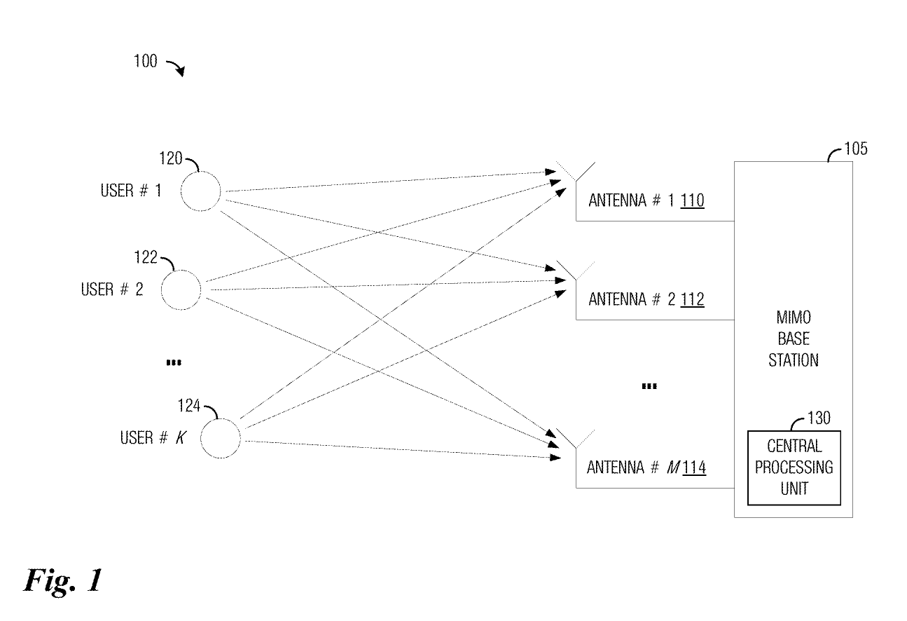

FIG. 1 illustrates an example communications system 100 highlighting MIMO reception. Communications system 100 includes a MIMO base station 105 serving K users, such as user #1 120, user #2 122, and user #K 124, where K is an integer number greater than or equal to 1. MIMO base station 105 includes M receive antennas, such as antenna #1 110, antenna #2 112, and antenna #M 114, where M is an integer number greater than or equal to 1. In a large scale MIMO implementation, M may be on the order of 100s, 1000s, 10000s, or even greater. A base station may also be referred to as an access point, a NodeB, an evolved NodeB (eNB), a communications controller, and so on, while a user may also be referred to as a mobile station, a mobile, a terminal, a subscriber, a user equipment (UE), and so forth. MIMO base station 105 also includes a central processing unit 130 configured to estimate signals transmitted by the users and received by MIMO base station 105.

While it is understood that communications systems may employ multiple base stations capable of communicating with a number of users, only one base station, and a number of users are illustrated for simplicity.

In communications system 100, the K users share the same communications system resources (such as time-frequency resources). To simplify discussion, each user is equipped with only one antenna. However, the example embodiments presented herein are operable with users with any number of antennas. Each of the M receive antennas at MIMO base station 105 are equipped with its own radio frequency (RF) hardware (such as filters, amplifiers, mixers, modulators, demodulators, constellation mappers, constellation demappers, and the like), analog to digital (A/D) converters, digital to analog (D/A) converters, as well as a local processing unit that is capable of performing a limited amount of processing. The local processing unit, the antenna and the associated hardware may be referred to as an antenna unit (AU). The local processing unit is referred to herein as an AU processing unit.

Communications system 100 may be represented as a mathematical model expressible as:

$$[ \begin{matrix}{y}_{1} \\ {y}_{2} \\ \cdot \\ \cdot \\ \cdot \\ {y}_{M}\end{matrix} ] = [ \begin{matrix}{a}_{1 , 1} & {a}_{1 , 2} & … & {a}_{1 , K} \\ {a}_{2 , 1} & {a}_{2 , 2} & … & {a}_{2 , K} \\ \cdot & \cdot & & \cdot \\ \cdot & \cdot & & \cdot \\ \cdot & \cdot & & \cdot \\ {a}_{M , 1} & {a}_{M , 2} & … & {a}_{M , K}\end{matrix} ] \cdot [ \begin{matrix}{x}_{1} \\ {x}_{2} \\ \cdot \\ \cdot \\ \cdot \\ {x}_{K}\end{matrix} ] + [ \begin{matrix}{n}_{1} \\ {n}_{2} \\ \cdot \\ \cdot \\ \cdot \\ {n}_{M}\end{matrix} ] or$$

$$Y = A \cdot X + N ,$$

where X is a transmitted symbol vector of length K in which each element xₖ represents a data symbol associated with user k; Y is a received sample vector of length M in which each element yₘ, represents a sample of receive antenna in; N is a receiver noise sample vector of length M in which each element nₘ represents the noise receive on receive antenna in, it is assumed that N is additive white Gaussian noise (AWGN); A is a channel matrix of size M by K in which each element a_{m,k} represents a channel transfer function between user k and receive antenna in; K is the number of users served by MIMO base station 105; and M is the number of receive antennas of MIMO base station 105. In general, a MIMO receiver has to resolve the above expression and given the received sample vector Y, find an estimate of the transmitted symbol vector X (denoted \hat{X}) that is as close as possible to the transmitted symbol vector X.

There is a plurality of techniques that a MIMO receiver, such as one implemented in a central processing unit located in a MIMO base station, can use to solve the above expression. A first MIMO decoder technique that may be used is referred to as a maximum likelihood (ML) decoder. A ML decoder searches for a solution that as minimum distance D between the received sample vector Y and the estimate of the transmitted symbol vector \hat{X}, which may be expressed mathematically as:

$${X}_{ML} = {arg min}_{\hat{X}} ( {( Y - A \cdot \hat{X} )}^{T} \cdot ( Y - A \cdot \hat{X} ) ) or$$

$${X}_{ML} = {arg min}_{\hat{X}} ( {( R - Acor \cdot \hat{X} )}^{T} \cdot ( R - Acor \cdot \hat{X} ) ) ,$$

where R=A^{T}·Y is a maximum ratio combining (MRC) vector of length K, Acor is an autocorrelation matrix with dimension K by K., and (.)^{T} is a transpose operator.

A second MIMO decoder technique that may be used is referred to as an interference cancelling (IC) decoder. An IC decoder checks all possible combinations of the estimate of the transmitted symbol vector \hat{X} to find the solution. The IC decoder iteratively searches for a ML solution that has the minimum distance by taking a gradient of the distance, which is a highly computationally intensive process. The IC decoder may be expressed mathematically as:

$$D = {( R - Acor \cdot \hat{X} )}^{T} \cdot ( R - Acor \cdot \hat{X} ) , \\ \frac{\partial D}{\partial \hat{X}} = 2 \cdot ( R - Acor \cdot \hat{X} ) ,$$

where Acor is an autocorrelation matrix with dimension K by K.

A third MIMO decoder technique that may be used is referred to as a MRC decoder. A MRC decoder attempts to find the solution by minimizing a signal to additive noise ratio. The MRC decoder may be expressed mathematically as:

$${X}_{MRC} = ( \frac{1}{{E}_{S}} ) \cdot R ,$$

where Eₛ is symbol energy and are diagonal elements of the autocorrelation matrix Acor.

A fourth MIMO decoder technique that may be used is referred to as a zero forcing (ZF) decoder. A ZF decoder attempts to find the solution by minimizing multi-user interference. The ZF decoder may be expressed mathematically as:

X_{ZF}=inv(Acor)·R.

A fifth MIMO decoder technique that may be used is referred to as a minimum mean square error (MMSE) decoder. A MMSE decoder is a compromise between MRC and ZF decoders and attempts to find the solution by minimizing a common mean square error. The MMSE decoder may be expressed mathematically as:

$${X}_{MMSE} = inv ( Acor + \frac{{σ}^{2}}{{E}_{S}} ) \cdot R .$$

It is noted that each of the five MIMO decoder techniques presented above have only two inputs:

R=A^{T}·Y(where R is a MRC vector of length K),

and

Acor=A^{T}·A (where Acor is an autocorrelation matrix with dimension K by K). The dimensions of both of the two inputs are dependent only on the number of users K and not on the number of receive antennas M. The number of users K places demands on the bit rate of the communications system, while the number of receive antennas M is representative of the number of receive antennas that can be associated with a base station (either actually located at the base station or controlled by the base station but remotely located). It is expected that both K and M will continue to grow, but M is expected to grow faster than K. In other words, M>>K. A summary of the five MIMO decoder techniques in equation form and their respective algorithm complexity is presented in tabular form.

TABLE
MIMO Decoding Technique Algorithm Complexity.

| MIMO | | |
|---|---|---|
| Decoder | | |
| Technique | Equation | Complexity |
| Maximum Likelihood | ${X}_{ML} = {arg min}_{{X}^{̑}} ( {( R - Acor \cdot {X}^{̑} )}^{T} \cdot ( R - Acor \cdot {X}^{̑} ) )$ | Combi- nation Number × |
| | | K × K |
| Interference Cancellation | $\frac{\partial D}{\partial \hat{X}} = 2 \cdot ( R - Acor \cdot {X}^{̑} )$ | Iteration Number × K × K |
| Maximum Ratio Combining | ${X}_{MRC} = ( \frac{1}{{E}_{S}} ) \cdot R$ | K |
| Zero | X_{ZF} = inv(Acor) · R | K × K |
| Forcing | | |
| Minimum Mean Square | ${X}_{MMSE} = inv ( Acor + \frac{{σ}^{2}}{{E}_{S}} ) \cdot R$ | K × K |
| Error | | |

Additionally, in the five MIMO decoder techniques presented above, a central processing unit located in the MIMO base station that is implementing one or more of the five MIMO decoder techniques does not need to know all inputs Y and channel estimates A of all of the M receive antennas. It is sufficient that the central processing unit has knowledge of the MRC vector R and the autocorrelation matrix Acor (with dimension K and K by K, respectively) to implement any and all of the five MIMO decoder techniques.

According to an example embodiment, each receive AU includes an AU processing unit which implement distributed computing to reduce computational load at the central processing unit, as well as the amount of data exchanged between the AUs and the central processing unit. Since the central processing unit that is implementing one or more of the five MIMO decoder techniques does not need to know all inputs Y and channel estimates A of all of the M receive antennas, it is possible to utilize AU processing units in the AUs to implement distributed (or cloud) computing. Results of the distributed computing performed at individual AUs are shared with other AUs, and eventually, the central processing unit where the results are used to estimate the received transmissions.

According to an example embodiment, a MRC vector R is represented as an accumulation of increments from the M receive antennas. The MRC vector R is expressible as

$$R = {A}^{T} \cdot Y = {\sum }_{m = 1}^{M} {R}_{m} and$$

$${R}_{m} = {A}_{m}^{T} \cdot {y}_{m}$$

where Rₘ is the component of the MRC vector R that is associated with receive antenna # m and is a vector of length K, yₘ is a sample that is received by receive antenna # m, and Aₘ is an m-th row of channel matrix A that is associated with receive antenna # m and is a vector of length K. Therefore, the MRC vector R may be simply generated by summing individual Rₘ components received from each of the M receive antennas. If the summation is performed at the AU processing units, the central processing unit may not need to perform significant processing to determine the MRC vector R.

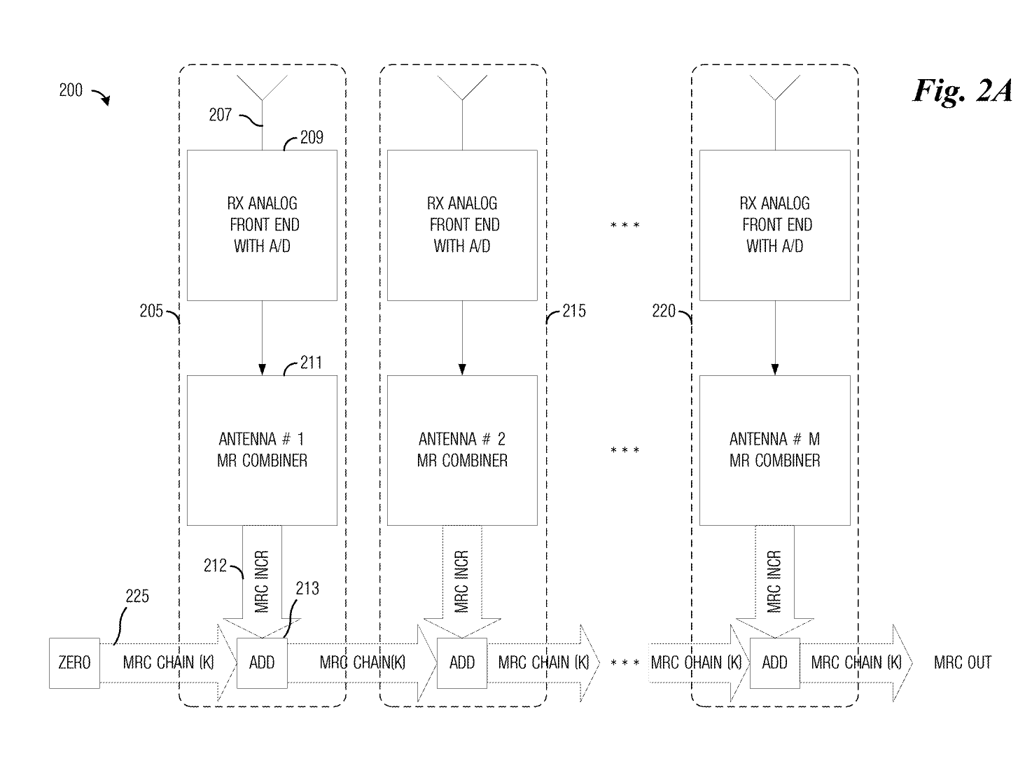

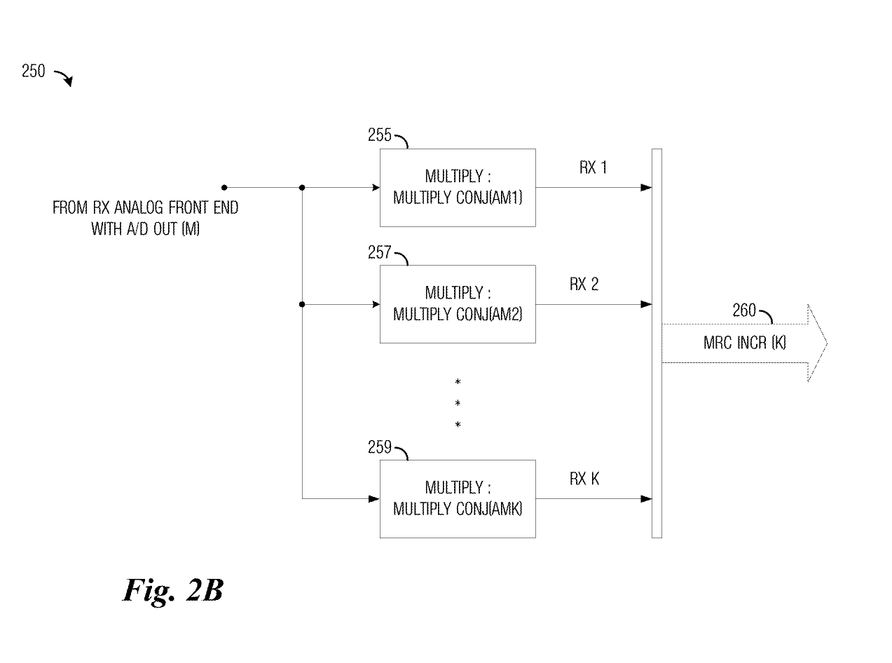

FIG. 2A illustrates a chain of AUs 200 configured to determine a MRC vector R in a distributed computing manner. Chain of AUs 200 includes a plurality of AUs, such as AU #1 205, AU #2 215, and AU #M 220. Each AU includes a receive antenna, such as receive antenna 207, and a receiver (RX) analog front end (which may include filters) with A/D converter, such as RX analog front end with A/D converter 209. The AU also includes a maximum ratio (MR) combiner, such as Antenna #1 MR combiner 211, configured to generate an individual MR component for the AU. The AU also includes an adder, such as adder 213, configured to accumulate an MR component from the MR combiner with an MR component from a first neighboring AU. The adder is coupled to the MR combiner over an MRC INCR connection, such as MRC INCR connection 212. In the case of AU #1 205, the MR component from the first neighboring AU is set to 0. Output of the adder is provided to a second neighboring AU. Inputs to and outputs from the adder are communicated over a MRC connection 225. Chain of AUs 200 is configured to operate in a pipelined fashion.

FIG. 2B illustrates an example MR combiner 250 of an AU. MR combiner 250 may be an implementation of a MR combiner of an AU in a chain of AUs configured to determine a MRC vector R in a distributed computing manner. MR combiner 250 may be implemented in hardware or software or a combination of hardware and software. MR combiner 250 includes K multipliers, such as multiplier 255, multiplier 257, and multiplier 259, wherein each of the K multipliers multiplies an accumulated value with a conjugate of an output of RX analog front end with A/D converter to produce a MRC component for each of the K users. Outputs from the K multipliers (the K MRC components) are outputted over MRC INCR channel 260 to an adder.

According to an example embodiment, an autocorrelation matrix Acor is represented as an accumulation of increments from the M receive antennas. The autocorrelation matrix Acor is expressible as

$$Acor = {A}^{T} \cdot A = {\sum }_{m = 1}^{M} {Acor}_{m} and$$

$${Acor}_{m} = {A}_{m}^{T} \cdot {A}_{m}$$

where Acorₘ is a component of the autocorrelation matrix that is associated with receive antenna # m, and Aₘ is an m-th row of channel matrix A that is associated with receive antenna # m and is a vector of length K. Therefore, the autocorrelation matrix Acor may be simply generated by summing individual Acorₘ components received from each of the M receive antennas. If the summation is performed at the AUs, the central processing unit may not need to perform significant processing to determine the autocorrelation matrix Acor.

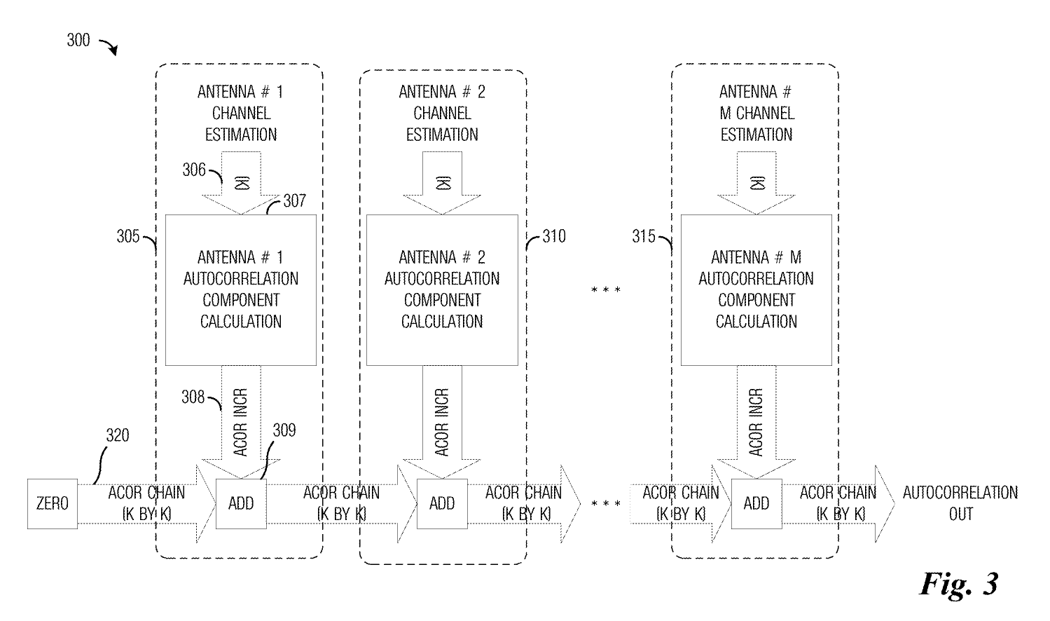

FIG. 3 illustrates a chain of AUs 300 configured to determine an autocorrelation matrix Acor in a distributed manner. Chain of AUs 300 includes a plurality of AUs, such as AU #1 305, AU #2 310, and AU #M 315. Each AU includes an autocorrelation component calculation unit, such as Antenna #1 autocorrelation component calculation unit 307, configured to determine an autocorrelation component Acorₘ in accordance with a channel estimate for the receive antenna. The autocorrelation component calculation unit is coupled to a receive antenna by a connection, such as connection 306. The AU also includes an adder, such as adder 309, configured to accumulate the autocorrelation component from the autocorrelation component calculation unit with an autocorrelation component from a first neighboring AU. The adder is connected to the autocorrelation component calculation unit with an ACOR INC connection, such as ACOR INC connection 308. In the case of AU #1, the autocorrelation component from the first neighboring AU is set to 0. Output of the adder is provided to a second AU. Inputs to and outputs from the adder are communicated over an ACOR connection 320. Chain of AUs 300 is configured to operate in a pipelined fashion.

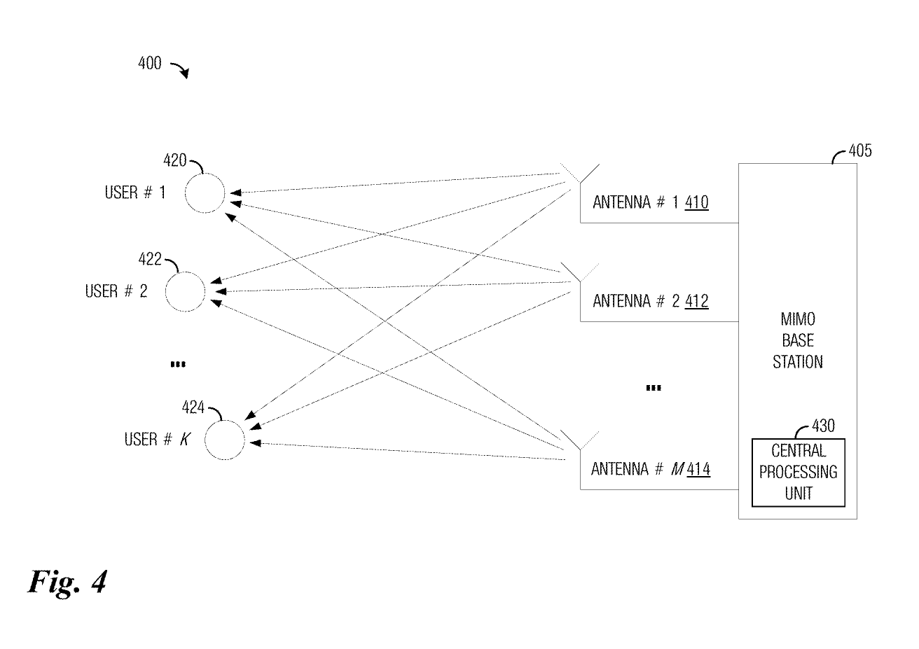

MIMO operations also include MIMO transmission. In MIMO transmission, 2 or more transmit antenna transmit to a single user. FIG. 4 illustrates an example communications system 400 highlighting MIMO transmission. Communications system 400 includes a MIMO base station serving K users, such as user #1 420, user #2 422, and user #K 424, where K is an integer number greater than or equal to 1. MIMO base station 405 includes M transmit antennas, such as antenna #1 410, antenna #2 412, and antenna #M 414, where M is an integer number greater than or equal to 2. In a large scale MIMO implementation, M may be on the order of 100s, 1000s, 10000s, or even greater. MIMO base station 405 also includes a central processing unit 430 configured to assist in precoding transmissions to the K users. Central processing unit 430 is also configured to assist in channel estimation.

Communications system 400 may be represented as a mathematical model expressible as:

$$[ \begin{matrix}{r}_{1} \\ {r}_{2} \\ \cdot \\ \cdot \\ \cdot \\ {r}_{K}\end{matrix} ] = [ \begin{matrix}{a}_{1 , 1} & {a}_{1 , 2} & … & {a}_{1 , M} \\ {a}_{2 , 1} & {a}_{2 , 2} & … & {a}_{2 , M} \\ \cdot & \cdot & & \cdot \\ \cdot & \cdot & & \cdot \\ \cdot & \cdot & & \cdot \\ {a}_{K , 1} & {a}_{K , 2} & … & {a}_{K , M}\end{matrix} ] \cdot [ \begin{matrix}{w}_{1 , 1} & {w}_{1 , 2} & … & {w}_{1 , K} \\ {w}_{2 , 1} & {w}_{2 , 2} & … & {a}_{2 , K} \\ \cdot & \cdot & & \cdot \\ \cdot & \cdot & & \cdot \\ \cdot & \cdot & & \cdot \\ {w}_{M , 1} & {w}_{M , 2} & … & {w}_{M , K}\end{matrix} ] \cdot [ \begin{matrix}{x}_{1} \\ {x}_{2} \\ \cdot \\ \cdot \\ \cdot \\ {x}_{K}\end{matrix} ]$$

$$or R = A \cdot W \cdot X + N ,$$

where X is a transmitted symbol vector of length K in which each element xₖ represents a symbol of user k; R is a received sampled vector of length K in which each element rₖ represents a sample received by user k; N is a received noise vector of length K in which each element nₖ represents noise received by user k (it is assumed that N is AWGN); A is a channel matrix of size M by K in which each element a_{m,k} represents the channel transfer function between user k and transmit antenna m; and W is a precoding matrix of size K by M.

There are several ways to define the precoding matrix W. A ZF precoding matrix fully removes multi-user interference and is expressible as

W=A^{T}·inv(A·A^{T})=A^{T}·inv(Acor)

where A^{T} is a transposed channel matrix of size K by M, and inv(Acor) is an inverse autocorrelation matrix of size M by M.

It is possible to re-express the above expression for R as

R=A·W·X+N=A·A^{T}·inv(Acor)·X+N=A·A^{T}·S+N

where S=inv(Acor)·X is a precoded symbol vector of length K. If M is sufficiently large, the autocorrelation matrix converges to an identify matrix (Acor=inv(Acor)=I). Therefore, it is possible to skip the multiplication by inv(Acor). Such a transmitter may be referred to as a MRC transmitter.

According to an example embodiment, it is also possible to perform MIMO precoding in a distributed computing manner. It is possible to make the following conclusions:

1. A central processing unit does not have to know channel matrix A with size M by K. It is sufficient to know a much smaller autocorrelation matrix Acor with size M by M.

2. Multiplication with the transposed channel matrix A^{T} with size K by M may be performed independently in each AU by the individual AU processing units, for example. Each AU may multiply precoded symbols vector S with a vector Aₘ^{T} that represents row # m of channel matrix A as related to transmit antenna m.

3. If the communications system is operating in time division duplexed (TDD) mode, an uplink channel estimate may be used as the downlink channel estimate.

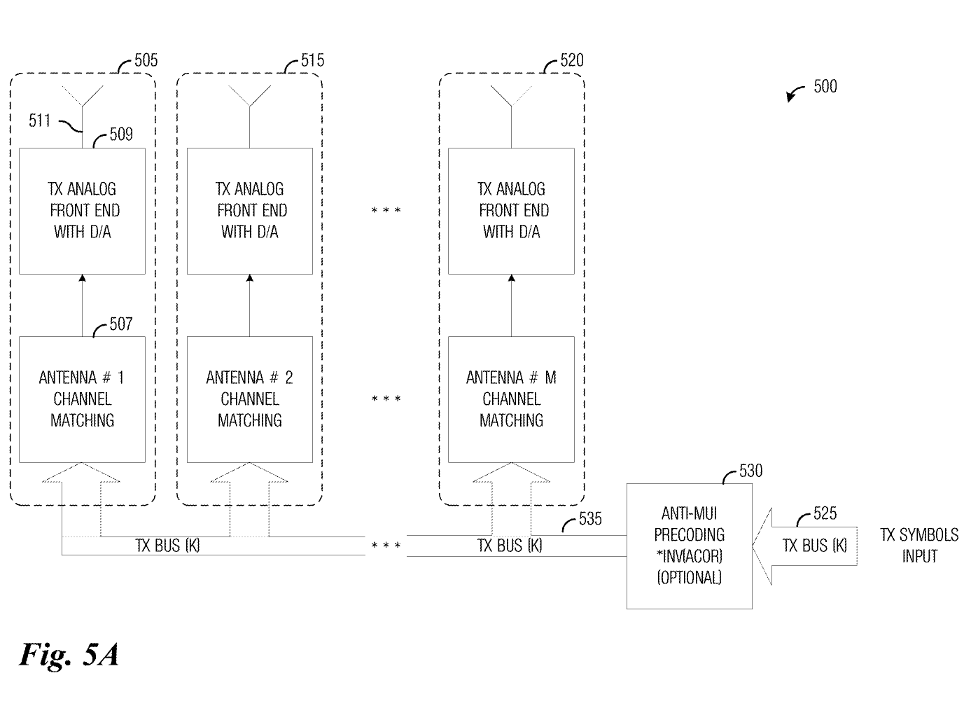

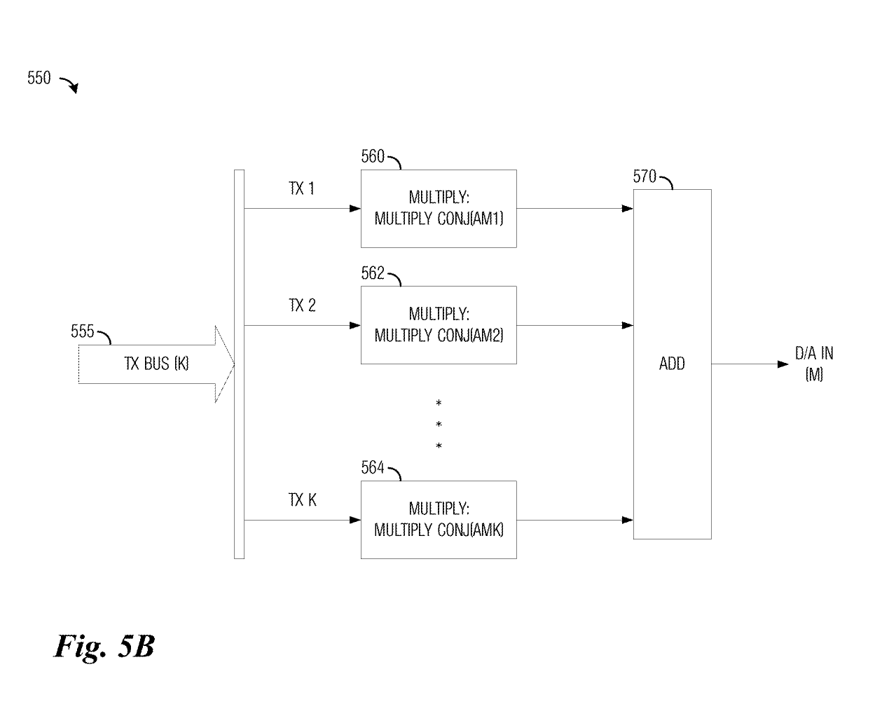

FIG. 5A illustrates a chain of AUs 500 configured to perform MIMO precoding in a distributed computing manner. Chain of AUs 500 includes a plurality of AUs, such as AU #1 505, AU #2 510, and AU #M 515. Each AU includes an antenna channel matching unit, such as antenna #1 channel matching unit 507, configured to apply a channel transfer function to transmission symbols prior to transmission. Each AU also includes a transmit analog front end with D/A converter, such as TX analog front end with D/A converter 509, which includes amplifiers, filters, constellation mappers, as well as a D/A converter, to generate transmission signals that are provided to a transmit antenna, such as a transmit antenna 511. Transmission symbols are provided over a TX bus 525 and anti-multiuser interference (ANTI-MUI) may be applied by an ANTI-MUI precoder 530. The transmission symbols are provided over a TX bus 535 to the plurality of AUs.

FIG. 5B illustrates an example channel matching unit 550 of an AU. Channel matching unit 550 may be an implementation of a channel matching unit of an AU in a chain of AUs configured to perform MIMO precoding. Channel matching unit 550 may be implemented in hardware or software or a combination of hardware and software. TX symbols are provided to channel matching unit 550 over a TX bus 555. Channel matching unit 550 includes K multipliers, such as multiplier #1 560, multiplier #2 562, and multiplier #K 564, wherein each of the K multipliers multiplies the TX symbols with a channel transfer function associated with a user. An adder 570 combines the outputs of the K multipliers and an output of adder 570 is provided to a D/A converter.

As discussed previously, a central processing unit does not need to know channel information of each transmit antenna. It is sufficient to know only accumulated autocorrelation matrix with a smaller size of K by K. Therefore, each AU may be able to maintain its own channel information without having to transfer the channel information to the central processing unit.

When dealing with the uplink (a transmission from a user to a base station), each user transmits its own reference signal for use in channel estimation. Therefore, the total number of reference signals is equal to the number of users K. Each AU (e.g., AU #m) may use the K reference signals to estimate channel vector Aₘ with length K. If a least mean squared (LMS) algorithm is used in the estimation, the estimated channel vector is expressible as

$${a}_{m , k} = \frac{1}{N} \cdot {\sum }_{n = 1}^{N} ( {y}_{m} \cdot {ref}_{k} ( n ) ) ,$$

where N is the length of the reference sequence (also referred to as accumulation length), yₘ is a sample that is received by receive antenna # m, and refₖ(n) is the reference signal for user k.

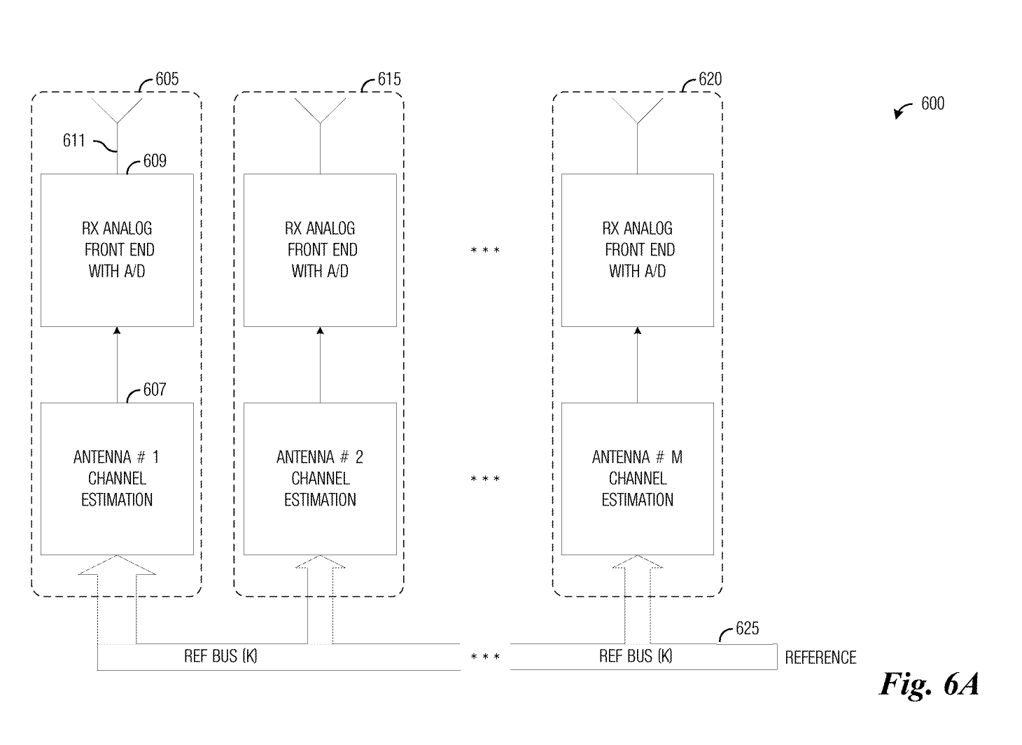

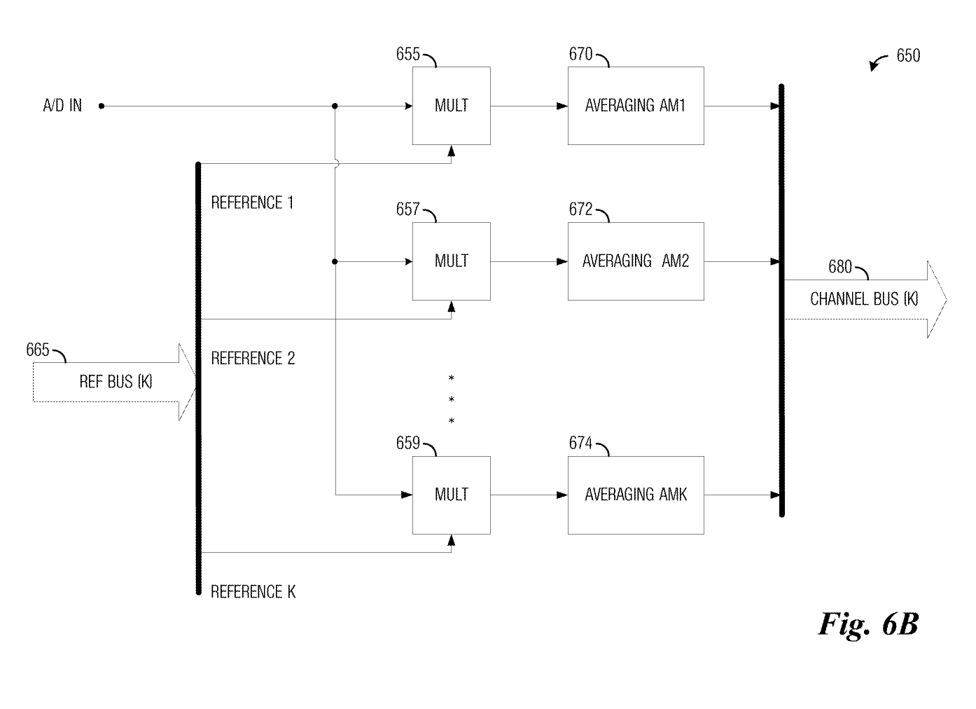

FIG. 6A illustrates a chain of AUs 600 configured to determine channel estimates in a distributed computing manner. Chain of AUs 600 includes a plurality of AUs, such as AU #1 605, AU #2 615, and AU #M 620. Each AU includes an antenna channel estimation unit, such as antenna #1 channel estimation unit 607, configured to estimate a channel between the AU and the users, and a receiver (RX) analog front end (which may include filters) with A/D converter, such as RX analog front end with A/D converter 609. Each AU also includes a receive antenna, such as receive antenna 611. The reference signals for the different users are provided to chain of AUs 600 by way of reference bus 625.

FIG. 6B illustrates an example antenna channel estimation unit 650. Antenna channel estimation unit 650 may be an implementation of an antenna channel estimation unit of an AU in a chain of AUs configured to determine channel estimates in a distributed computing manner. Antenna channel estimation unit 650 may be implemented in hardware or software or a combination of hardware and software. Antenna channel estimation unit 650 includes K multipliers, such as multiplier 655, multiplier 657, and multiplier 659, configured to multiply the reference signals associated with the users (provided by reference bus 665 that has width K) with received signals from an RX analog front end with A/D converter. Antenna channel estimation unit 650 also includes K averaging units, such as averaging unit 670, averaging unit 672, and averaging unit 674, configured to maintain an average (e.g., a running average) of outputs of the multipliers, thereby producing channel estimates for each of the K users.

According to an example embodiment, a MIMO communications device with an array of AUs is presented. The MIMO communications device includes a central processing unit includes an array of AUs, where the AUs in the array are arranged as an array. Each AU includes a transmit antenna, a receive antenna, and associated RF hardware. Each AU also includes an AU processing unit configured to process information in a distributed computing manner. The AU processing units may process only information associated with AU or the AU processing unit may process information associated with the AU as well as share information with neighboring AUs. The distributed processing performed by the AU processing units may help to reduce computational load at the central processing unit as well as data bandwidth requirements for buses connecting the central processing units to the AUs.

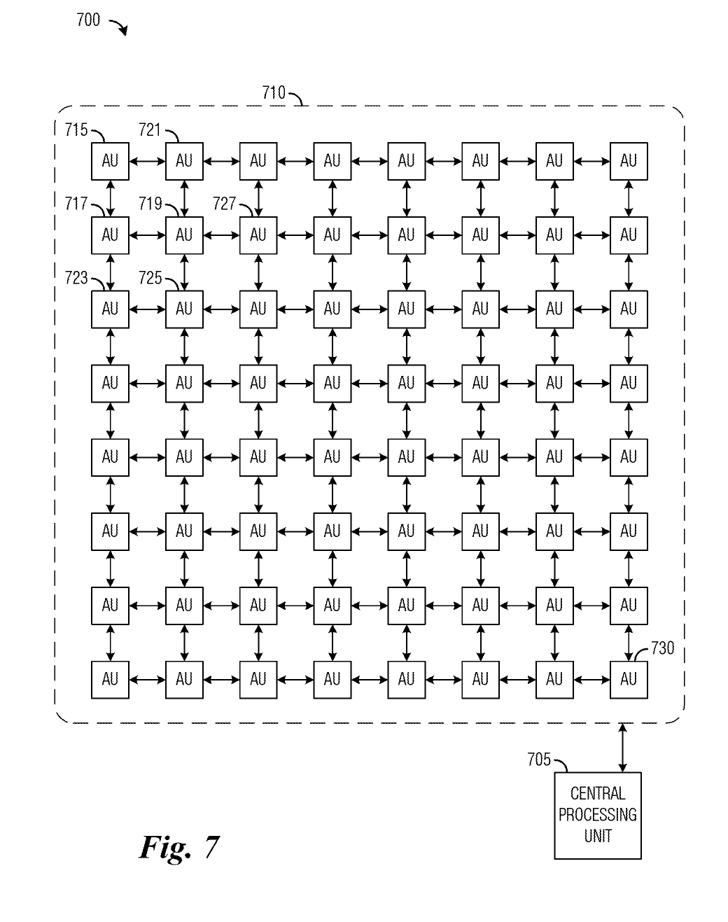

FIG. 7 illustrates a first example MIMO communications device 700, highlighting the architecture of MIMO communications device 700. MIMO communications device 700 includes a central processing unit 705 and an array of AUs 710 coupled to central processing unit 705. Array of AUs 710 may include any number of AUs, but for large scale MIMO implementations, it is expected that array of AUs 710 includes on the order of hundreds, thousands, tens of thousands, or more AUs. Central processing unit 705 may be a single processor or a multi-processor system. Not shown in FIG. 7 are ancillary circuitry such as memories, network interfaces, user interfaces, power supplies, and so forth.

Array of AUs 710 may be arranged in a mesh configuration. Each AU in array of AUs 710 are connected to a subset of neighboring AUs. As an illustrative example, AU 715 is located at a vertex and is connected to two neighboring AUs (AU 717 and AU 721). While AU 717 is located on an edge and is connected to three neighboring AUs (AU 715, AU 719, and AU 723) and AU 719 is located in a field of AUs and is connected to four neighboring AUs (AU 717, AU 721, AU 725, and AU 727). The AUs in array of AUs 710 may be connected to central processing unit 705 by one or more buses. Alternatively, central processing unit 705 may be connected to a subset of the AUs in array AUs 710. As an illustrative example, array of AUs 710 may include an end AU 730 that is connected to a subset of neighboring AUs (two neighboring AUs as shown in FIG. 7) and central processing unit 705.

The AUs in array of AUs 710 may be spaced regularly apart from one another, e.g., the AUs (or the antennas therein) are spaced one-half wavelength apart. Alternatively, the AUs in array of AUs 710 may be irregularly spaced apart from one another, e.g., some AUs may be spaced regularly apart while others may be irregularly spaced apart, or none of the AUs are spaced apart by the same amount.

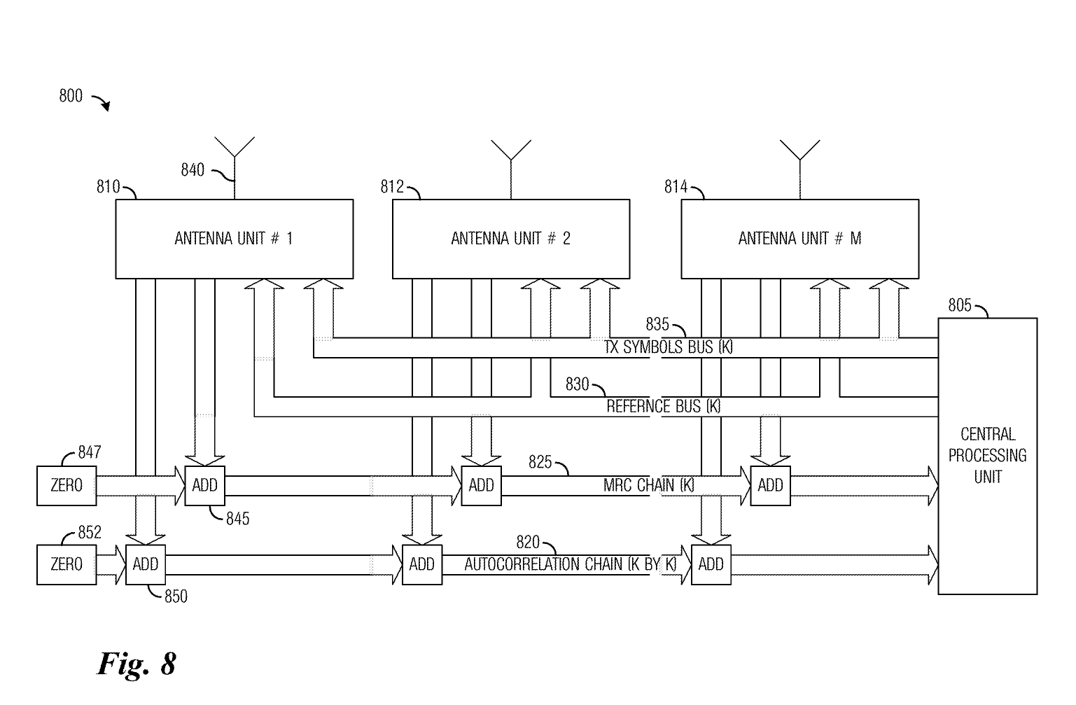

FIG. 8 illustrates a detailed view of a second example MIMO communications device 800, highlighting interconnections between components of MIMO communications device 800. MIMO communications device 800 includes a central processing unit 805 connected to a plurality of AUs (such as AU 810, AU 812, and AU 814), wherein the plurality of AUs may be arranged in an array of AUs but are shown as a linear sequence to simplify the figure. Central processing unit 805 is connected to the plurality of AUs with an autocorrelation connection 820 (used to exchange autocorrelation matrices), a MRC connection 825 (used to exchange MRC vectors), a reference connection 830 (used to exchange reference signals), and a TX symbols connection 835 (used to exchange TX symbols to be transmitted).

Autocorrelation connection 820 allows for the exchange of the accumulated autocorrelation matrix and has sufficient bandwidth to support the transfer of K by K-sized matrices. MRC connection 825 allows for the exchange of the accumulated MRC vector and has sufficient bandwidth to support the transfer of K-sized vectors. Reference connection 830 allows for the exchange of reference signals for use in channel estimation and has sufficient bandwidth to support the transfer of K-sized vectors. TX symbols connection 835 allows for the exchange of TX symbols for transmission precoding and transmission and has sufficient bandwidth to support the transfer of K-sized vectors. The connections may be bi-directional in nature, allowing the AUs in the plurality of AUs to exchange information with one another. A control bus allows for the exchange of control signals regulating the operation of MIMO communications device.

MIMO communications device 800 includes a plurality of adders (such as adders 845 and 850) to accumulate information from neighboring AUs. As shown in FIG. 8, information, after accumulation in a first adder is provided as input to a second adder associated with a neighboring AU. Adders associated with a first AU (i.e., AU 810) are provided with zeroes as input by zeroes 847 and 852. Each AU also includes antennas (such as antenna 840 for AU 810). Although shown in FIG. 8 as a single antenna, each AU includes a receive antenna and a transmit antenna, which may be implemented as a single antenna with a duplexer or as two distinct antennas.

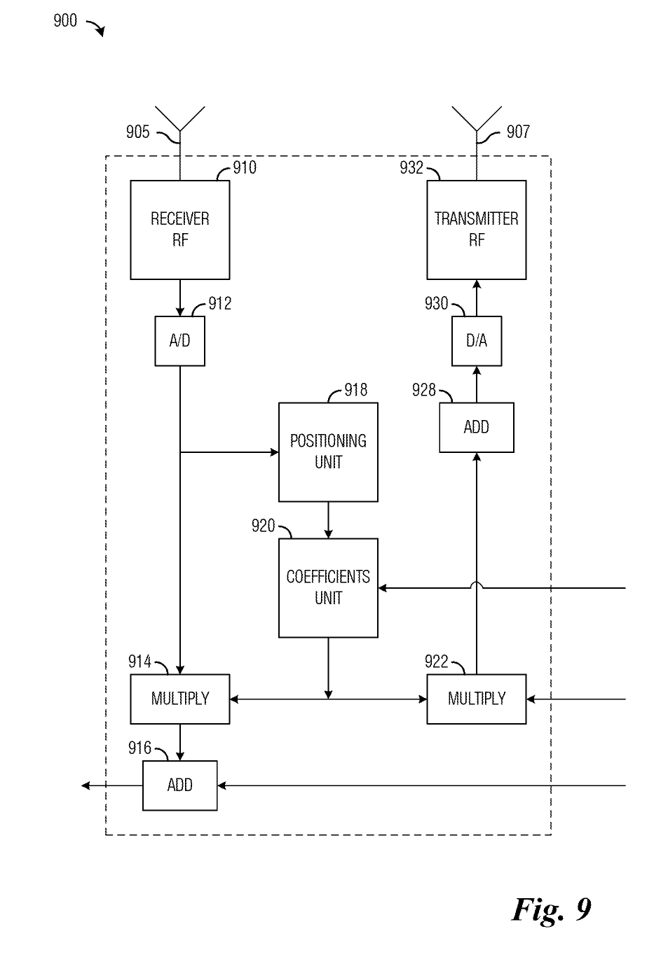

FIG. 9 illustrates a detailed view of an example AU 900. AU 900 includes a receive antenna 905 and a transmit antenna 907, although it is possible to share a single antenna through the use of a duplexer. AU 900 also includes receiver RF circuitry 910, which may include filters, demodulators, constellation demappers, and the like, and an A/D converter 912. A multiply unit 914 is configured to multiply received signals with coefficients provided by a coefficients unit 920. As an illustrative example, the received signals may be multiplied by a reference signal, or a channel matrix. An adder 916 is configured to accumulate results of multiplier 916 along with shared information provided by a neighboring AU. The accumulated result of adder 916 may be shared with another neighboring AU or with a central processing unit.

A positioning unit 918 is configured to assist in determining a position of AU 900 using received reference signals, while a multiply unit 922 is configured to multiply coefficients provided by coefficients unit 920 with signals provided by the central processing unit. As an illustrative example, multiply unit 922 may multiply transmission symbols provided by the central processing unit with channel transfer functions. An adder 928 combines the outputs of multiplier 928 and provides the combine value to a D/A converter 920. AU 900 also includes transmitter RF circuitry 932, which may include filters, modulators, constellation mappers, and so on.

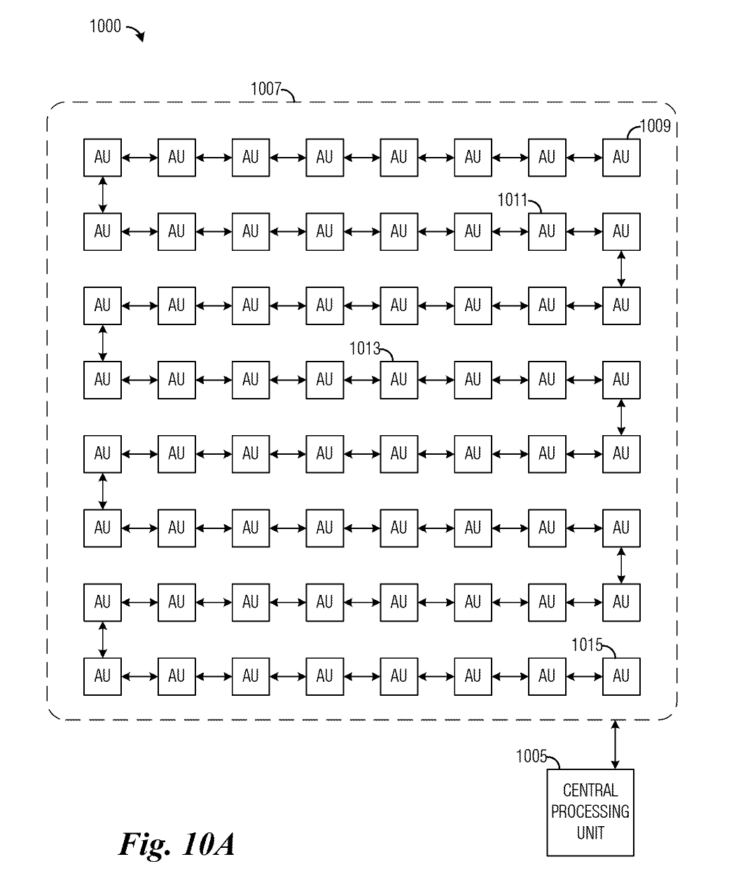

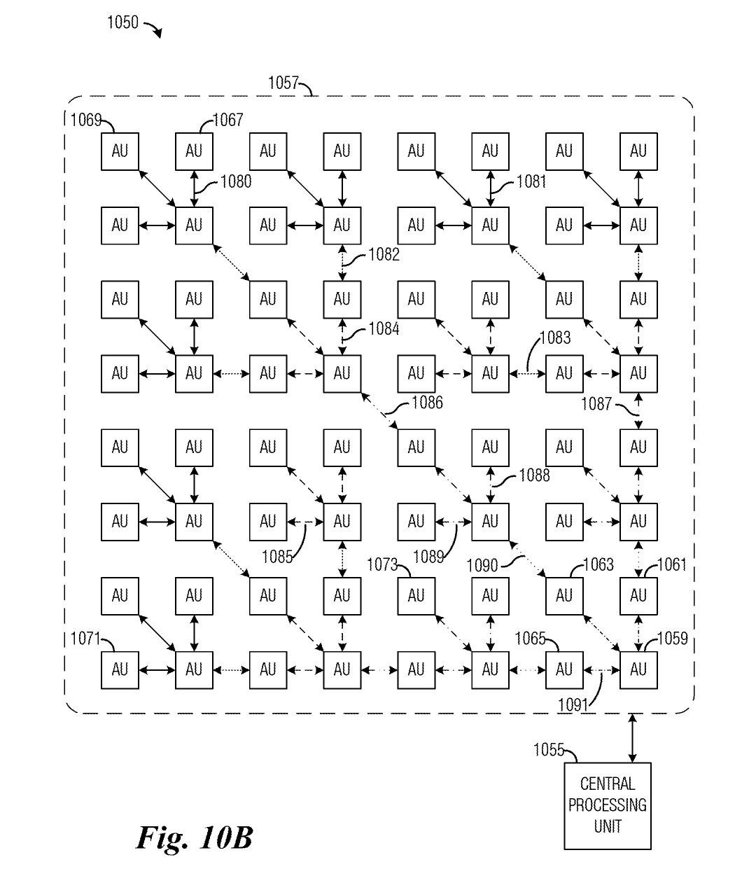

FIG. 10A illustrates a second example MIMO communications device 1000, highlighting the architecture of MIMO communications device 1000. MIMO communications device 1000 includes a central processing unit 1005 and an array of AUs 1007 coupled to central processing unit 1005. Array of AUs 1007 may be arranged in a linear configuration. Each AU in array of AUs 1007 is connected to a subset of neighboring AUs. As an illustrative example, AU 1009 is at a start of the linear array and is connected to a single neighboring AU, while AUs 1011 and 1013 are in the linear array and is connected to two neighboring AUs. The AUs in array of AUs 1007 may be connected to central processing unit 1005 by one or more buses. Alternatively, central processing unit 1005 may be connected to a subset of the AUs in array AUs 1007. As an illustrative example, AU 1015 is an end AU and is connected to one neighboring AUs and central processing unit 1005.

FIG. 10B illustrates a third example MIMO communications device 1050, highlighting the architecture of MIMO communications device 1050. MIMO communications device 1050 includes a central processing unit 1055 and an array of AUs 1057 coupled to central processing unit 1055. Array of AUs 1057 may be arranged in a tree configuration. Each AU in array of AUs 1057 is connected to a subset of neighboring AUs. As an illustrative example, AU 1059 is at a start of the tree and is connected to three neighboring AU, while AUs 1061, 1063, and 1065 are edge AUs and are connected to two neighboring AUs. Lowest level AUs, such as AUs 1067, 1069, 1071, and 1073, are coupled to a single neighboring AU. The AUs in array of AUs 1057 may be connected to central processing unit 1055 by one or more buses. Alternatively, central processing unit 1055 may be connected to a subset of the AUs in array AUs 1057. As an illustrative example, AU 1059 is an end AU and is connected to three neighboring AUs and central processing unit 1055.

In FIG. 10B, different line types indicate different phases of MRC vector and autocorrelation matrix accumulation. As an example, solid lines (such as lines 1080 and 1081) represent accumulations that occur at a first phase, short dotted lines (such as lines 1082 and 1083) represent accumulations that occur at a second phase, long dashed lines (such as lines 1084 and 1085) represent accumulations that occur at a third phase, dashed double dotted lines (such as lines 1086 and 1087) represent accumulations that occur at a fourth phase, dashed dotted lines (such as lines 1088 and 1089) represent accumulations that occur at a fifth phase, thin dotted lines (such as line 1090) represent accumulations that occur at a sixth phase, and thin dashed dotted lines (such as line 1091) represent accumulations that occur at a seventh phase. It is noted that the accumulations occur in a pipelined manner and once an initial accumulation occurs in a particular phase (as indicated above), subsequent accumulations of further arriving information occur in follow-on phases. Therefore, for the 64 AU array of AUs 1057, it takes 7 phases for AU 1059 to have the accumulated MRC vector and autocorrelation matrix for a first received symbols vector, in a next phase (i.e., an eighth phase) AU 1059 will have the accumulated MRC vector and autocorrelation matrix for a second received symbols vector, and so on.

According to an example embodiment, a MIMO communications device with a distributed array of AUs is presented. The example MIMO communications devices discussed in FIGS. 7, 10A, and 10B feature a single array of AUs that is directly coupled to the central processing unit. It is also possible to have one or more distributed arrays of AUs coupled to a central processing unit. The one or more distributed arrays of AUs may be coupled to the central processing unit by way of a high-speed connection. The one or more distributed arrays may have the same configuration. The one or more distributed arrays may have different configurations. The one or more distributed arrays may all have the same number of AUs in each array. The one or more distributed arrays may have different numbers of AUs in each array. The one or more distributed arrays may have some arrays having the same number of AUs and/or the same configuration, while other arrays having different numbers of AUs and/or different configurations.

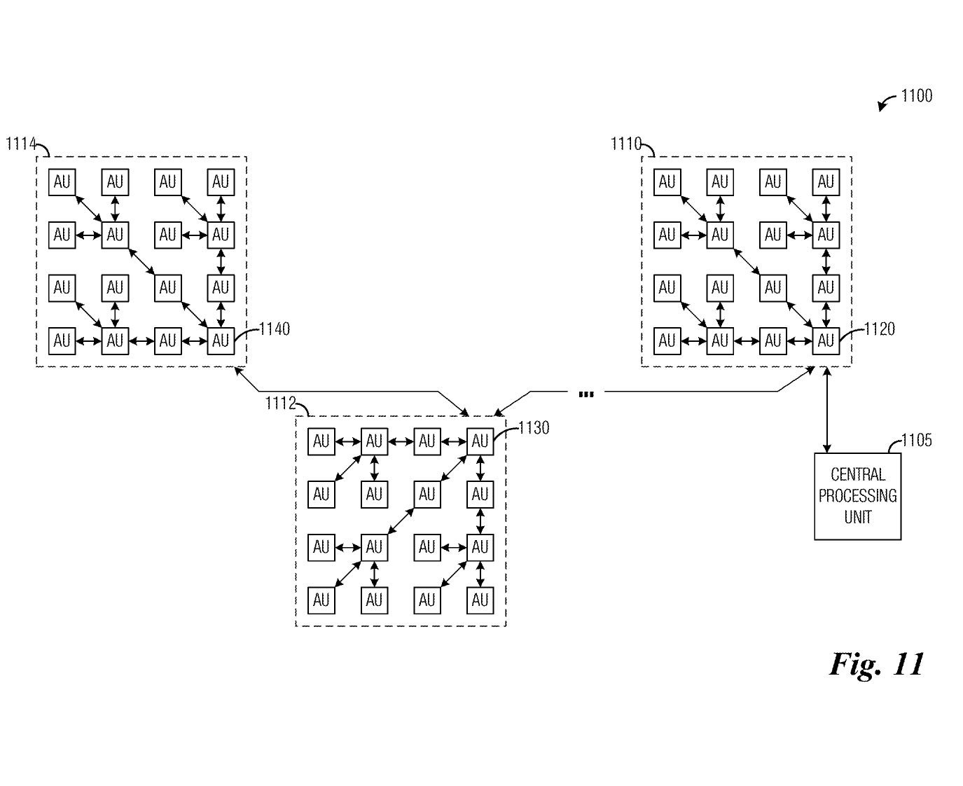

FIG. 11 illustrates an example MIMO communications device 1100, highlighting distributed arrays of AUs. MIMO communications device 1100 includes a central processing unit 1105 that is coupled to a plurality of arrays of AUs (each array of AUs is referred to as a leaf). As shown in FIG. 11, central processing unit 1105 is coupled to leaves 1110, 1112, and 1114. As an illustrative example, the leaves of MIMO communications device 1100 may be remotely control antennas or antenna arrays, such as remote radio heads (RRH), or distributed antennas. The leaves shown in FIG. 11 have the same number of AUs and are configured the same way. However, the leaves may have different configurations and/or different numbers of AUs. Therefore, the illustration and discussion of all leaves having the same number of AUs and the same configuration should not be construed as being limiting to either the scope or the spirit of the example embodiments. Furthermore, central processing unit 1105 may be directly coupled to a leaf, such as leaf 1110. In other words, central processing unit 1105 and leaf 1110 may be a MIMO communications device as shown in FIGS. 7, 10A, and 10B.

The leaves may be coupled to each other (and the central processing unit) by way of a high speed bus or connection. As shown in FIG. 11, an end AU of a first leaf is connected to an end AU of a second leaf and so on. In general, any AU in any leaf may be connected to any AU in another leaf. However, resulting latency may be sub-optimal.

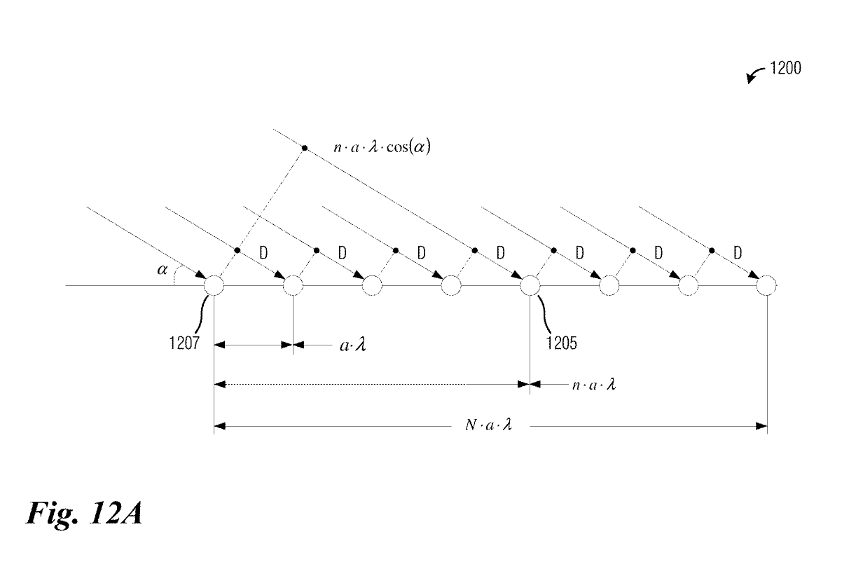

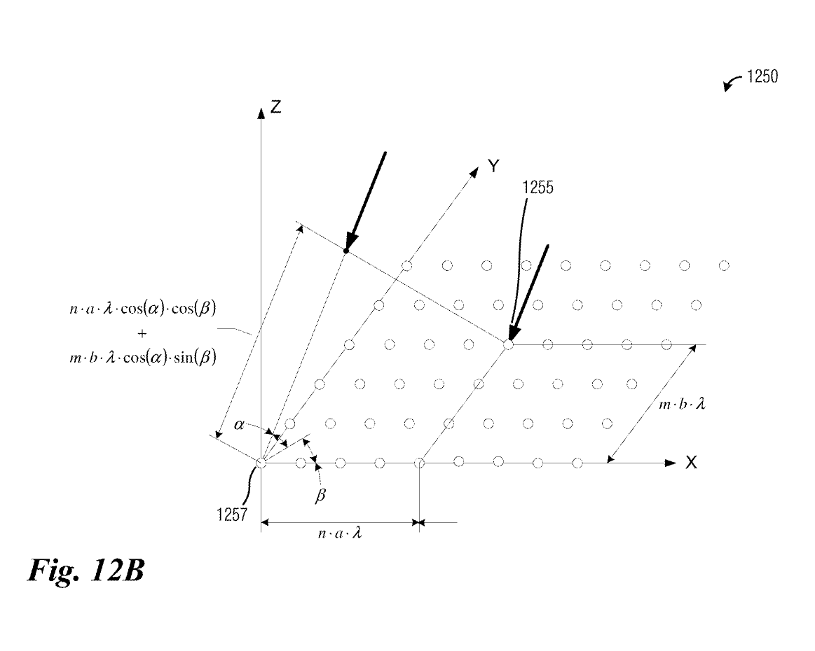

In a typical massive MIMO implementation, a large number (M×N) omni-directional antennas are mounted on a flat surface with a consistent spacing between antennas (a·λ×b·λ), where N and M are integer values and l is wavelength of a signal. FIG. 12A illustrates a one-dimensional massive MIMO antenna 1200. In such a configuration, an antenna #n 1205 has coordinate (n·a·λ,0) in plane (x, y) centered at antenna #0 1207 when the spacing between consecutive antennas is a·λ. If a beam arrives at one-dimensional MIMO antenna 1200 with angle a, the beam arrives at antenna #n with a delay that is equal to a length of an orthogonal projection of a normalized vector D with angle a and the coordinate of antenna #n 1205 divided by the speed of light c, expressible as

$${t}_{n} = \frac{{D}_{n}}{c} = n \cdot \frac{D}{c} = n \cdot \frac{a \cdot λ}{c} \cdot cos ( α ) .$$

Therefore, the beam arrives at antenna #n 1205 with a complex gain expressible as

$${H}_{n} ( α ) = exp ( j \cdot 2 \cdot π \cdot \frac{c \cdot {t}_{n}}{λ} ) = exp ( j \cdot 2 \cdot π \cdot a \cdot cos ( α ) ) .$$

Hence, antenna arrays that are tuned to the receive the signal from direction a may be configured with coefficients that match the complex gain Hₙ*(α).

FIG. 12B illustrates a two-dimensional massive MIMO antenna 1250. In such a configuration, an antenna (n, m) 1255 has coordinates (n·a·λ, n·b·λ,0) in space (x, y, z) centered at antenna (0, 0) 1257. If a beam arrives at two-dimensional MIMO antenna 1250 with angle (a, b), the beam arrives at antenna (n, m) 1255 with a delay that is equal to a length of an orthogonal projection of a normalized vector with angle (a, b) and the coordinates of antenna (n, m) 1255 divided by the speed of light c, expressible as

$${t}_{n , m} = \frac{{D}_{n , m}}{c} = n \cdot \frac{a \cdot λ}{c} \cdot cos ( α ) \cdot cos ( β ) + m \cdot \frac{b \cdot λ}{c} \cdot cos ( α ) \cdot sin ( β ) .$$

Therefore, the beam arrives at antenna (n, m) 1255 with a complex gain expressible as

$${H}_{n , m} ( α , β ) = exp ( j \cdot 2 \cdot π \cdot \frac{c \cdot {t}_{n , m}}{λ} ) or$$

$${H}_{n , m} ( α , β ) = exp ( j \cdot 2 \cdot π \cdot ( n \cdot a \cdot cos ( α ) \cdot cos ( β ) + m \cdot b \cdot cos ( α ) \cdot sin ( β ) ) ) .$$

Hence, antenna arrays that are tuned to the receive the signal from direction a may be configured with coefficients that match the complex gain H_{n,m}*(α, β).

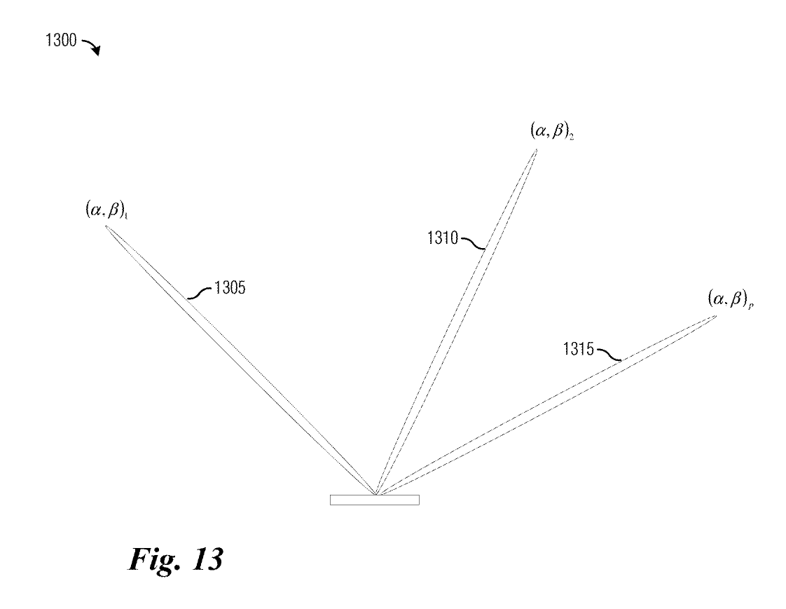

The discussion regarding FIGS. 12A and 12B presented above shows that it is possible to generate beams that have desired directions (α, β). FIG. 13 illustrates a plurality of antenna beams 1300. Plurality of antenna beams 1300 includes antenna beam 1305 with direction (α, β)₁, antenna beam 1310 with direction (α, β)₂, and antenna beam 1315 with direction (α, β)₃. In order to generate antenna beams with desired directions (α, β), a MIMO communications device may have to be able to determine the desired directions (α, β).

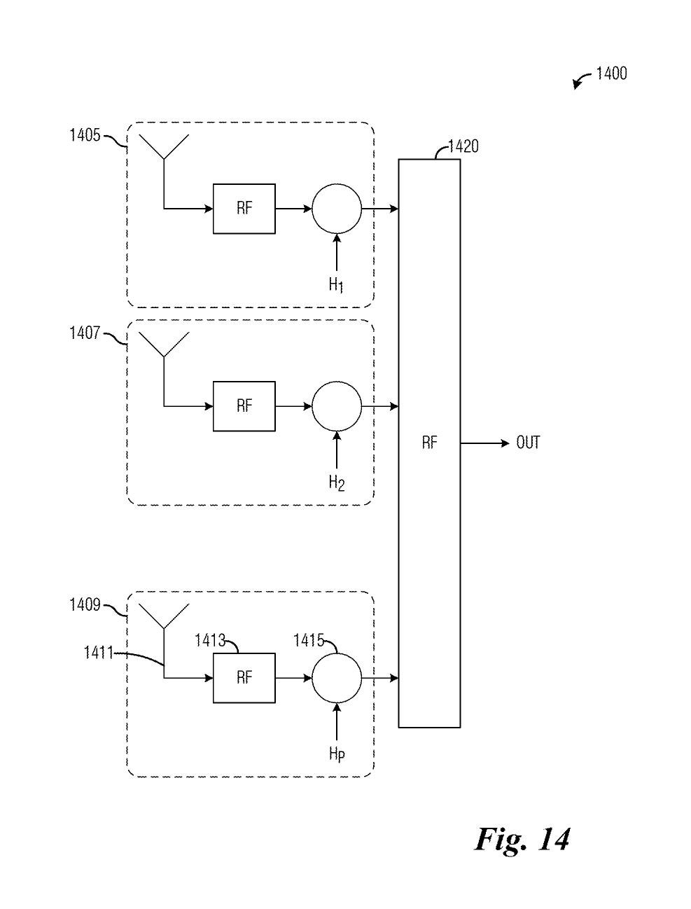

FIG. 14 illustrates the architecture of a portion of an example massive MIMO multi-beam receiver 1400. Massive MIMO multi-beam receiver 1400 includes a plurality of receive antenna units, such as receive antenna unit #1 1405, receive antenna unit #2 1407, and receive antenna unit #P 1409. Each receive antenna unit includes a receive antenna, such as receive antenna 1411, a RF front end, such as RF front end 1413, and a multiplier, such as multiplier 1415. Massive MIMO multi-beam receiver 1400 also includes RF circuit 1420 that combines outputs from the plurality of receive antenna units.

In general, the coefficients for receive antenna unit #P 1409 for a single antenna beam with angle (α, β) is expressible as

$${\overline{H}}_{p} ( α , β ) = exp ( j \cdot 2 \cdot π \cdot \frac{\begin{matrix}( {x}_{p} - {x}_{0} ) \cdot cos ( α ) \cdot cos ( β ) + \\ ( {y}_{p} - {y}_{0} ) \cdot cos ( α ) \cdot sin ( β ) + ( {z}_{p} - {z}_{0} ) \cdot sin ( α )\end{matrix}}{λ} ) ,$$

where (x, y, z)ₚ is the coordinates of receive antenna unit #p 1409, and (x₀, y₀, z₀)_{P} is the reference coordinates of massive MIMO multi-beam receiver 1400. Similarly, the coefficients for receive antenna unit #P 1409 for multiple beams with multiple angles is expressible as

$${H}_{p} = {\sum }_{k = 0}^{K - 1} {\overline{H}}_{p} ( {α}_{k} , {β}_{k} ) .$$

However, determining the angles for the multiple beams may be a difficult task since a search space to determine the angles is very large. Therefore, the scanning of the search space to find the angles with the most energy can take an extended amount of time. Furthermore, since the beam width of antenna beams generated by a communications device (e.g., a massive MIMO multi-beam receiver) is inversely proportional to the number of antennas, the scan of the search space takes an even greater amount of time due to the narrow beam width of the antenna beams generated by the massive MIMO multi-beam receiver.

According to an example embodiment, a distributed approach is applied to the scanning of the search space to find the angles with the most energy. The search space is partitioned into a plurality of independent portions that may be separately scanned. Since each independent portion is smaller, the scan of each independent portion will take less time.

According to an example embodiment, the inverse relationship between the beam width of antenna beams generated by a communications device and the number of antennas of the communications device used to generate the antenna beams is exploited. Since the beam width of the antenna beams will generally increase as the number of antennas used to generate the antenna beams, the number of antennas used to generate the antenna beams that are used in the scanning of the search space is decreased to increase the beam width of the antenna beams. The greater beam width of the resulting antenna beams may shorten the amount of time to scan the search space due to increased search granularity.

According to an example embodiment, both the distributed approach and the antenna beam width are used to help accelerate the scan of the search space. The combining of both techniques may help further speed up the finding of the angles of the antenna beams.

According to an example embodiment, once the angles of the antenna beams are found, antenna beams with narrower beam widths are used to increase precision. A two-stage process is used to increase performance. In a first stage, the finding of the angles of the antenna beams is performed quickly with smaller search spaces and wider beam widths, while in a second stage, after the angles have been found increased precision is achieved by using antenna beams with narrower beam widths.

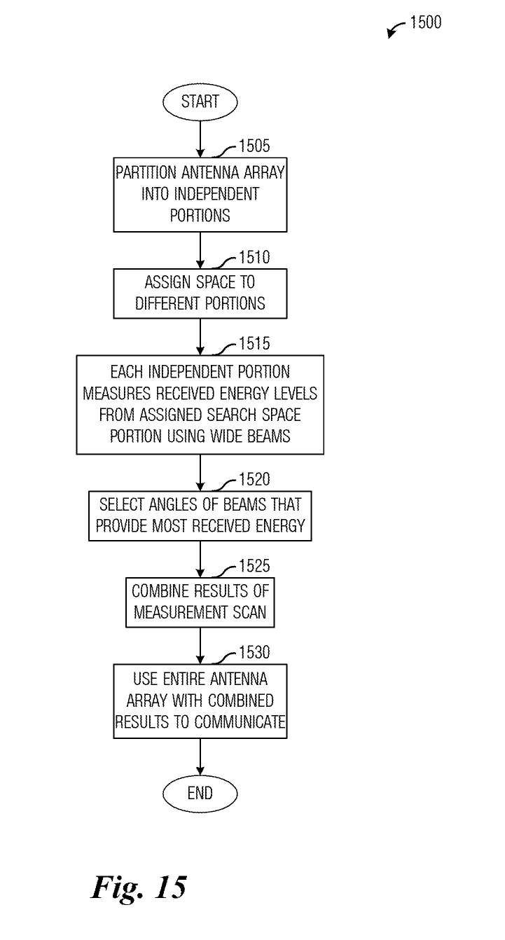

FIG. 15 illustrates a flow diagram of example operations 1500 occurring in a fast determining of antenna beams for a massive MIMO communications device. Operations 1500 may be indicative of operations occurring in a massive MIMO communications device, such as MIMO communications devices shown in FIGS. 7, 10A, 10B, and 11.

Operations 1500 may begin with a partitioning of an antenna array into a plurality of independent antenna array portions (block 1505). The antenna array may be partitioning into an integer number of independent antenna array portions. As illustrative examples, the antenna array is partitioned into 2, 4, 8, 16, and so on, independent antenna array portions. In general, as the number of antennas in the independent antenna array portions decreases as the number of independent antenna array portions increases. However, overhead also increases. Each independent antenna array portion may contain about the same number of antennas to simplify implementation. Each independent antenna array portion is assigned to scan a different part of the search space (block 1510). The search space may be partitioned into a plurality of search space portions. The number of search space portions may be equal to the number of independent antenna array portions. Alternatively, there may be more search space portions than the number of independent antenna array portions. In such a situation, each independent antenna array portion scans one or more search space portions.

Each independent antenna array portion measures received energy from the search space portion(s) assigned to it (block 1515). Since the independent array portions comprise a smaller number of antennas than the antenna array, the beam widths of the antenna beams will be greater, thereby speeding up the scan of the search space portion(s). As an illustrative example, a measurement process includes a central processing unit associated with an independent antenna array portion configures an antenna beam so that it is directed inside the search space portion assigned to the independent antenna array portion and measures an energy level associated by the antenna beam. The central processing unit continues the measurement process with other antenna beams until the search space portion has been measured. If the independent antenna array portion has been assigned multiple search space portions, the measurement process may continue until all assigned multiple search space portions have been scanned.

The antenna beam(s) associated with the highest energy levels are selected (block 1520). The number of antenna beams selected may be a configurable number. As an illustrative example, if there is a large number of search space portions, only a relatively small number of antenna beams are selected (for example, 1 or 2 antenna beams per search space portion). While, if there is a small number of search space portions, a relatively large number of antenna beams are selected (for example, 4 or 5 antenna beams per search space portion). Alternatively, every antenna beam with a measured energy level exceeding a threshold is selected. Alternatively, a combination of a number of antenna beams and a threshold is used in the selection of antenna beams. The selected antenna beams from different search space portion is combined (block 1525). The antenna array, in its entirety, is used with the selected antenna beams to communicate (block 1530). The use of the antenna array, with its larger number of antennas, results in narrower beam width antenna beams. The narrower beam width antenna beams provide greater precision, such as in receiving more of a transmission to the massive MIMO communications device while receive less noise and/or interference since the transmission encompasses a larger percentage of the narrower beam width antenna beam.

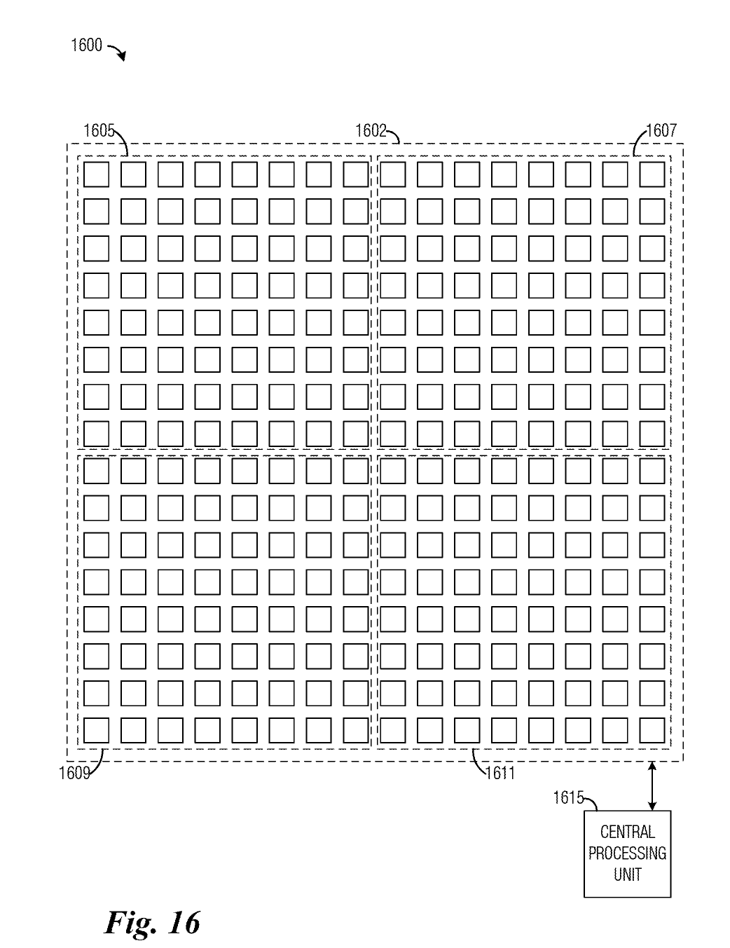

FIG. 16 illustrates an example massive MIMO communications device 1600, highlighting a partitioned antenna array. Massive MIMO communications device 1600 includes an antenna array 1602 that is partitioned into 4 independent antenna array portions 1605, 1607, 1609, and 1611. Massive MIMO communications device 1600 also includes a central processing unit 1615 operatively coupled to antenna array 1602. Each independent antenna array portion is capable of scanning a search space using antenna beams and measuring received energy.

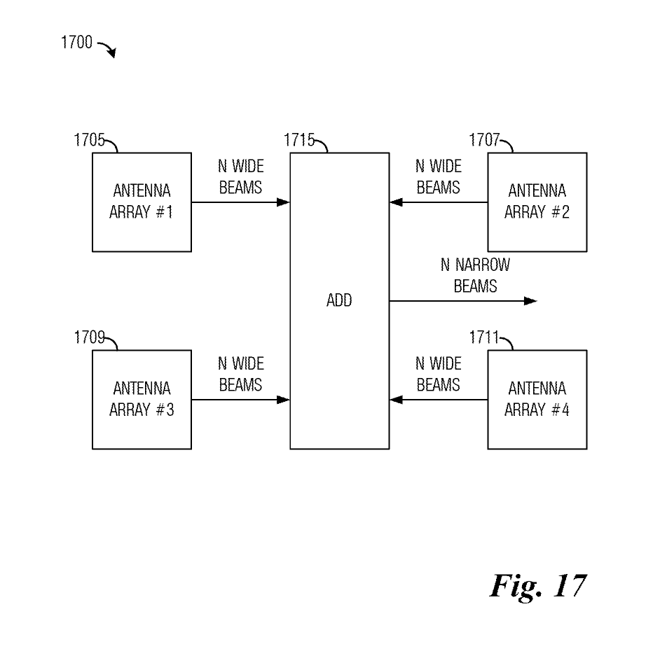

FIG. 17 illustrates an example combining circuit 1700. Combining circuit 1700 combines N wide beam width antenna beams from four independent antenna array portions 1705, 1707, 1709, and 1711, with an adder 1715 to produce N narrow beam width antenna beams, where N is a positive integer value.

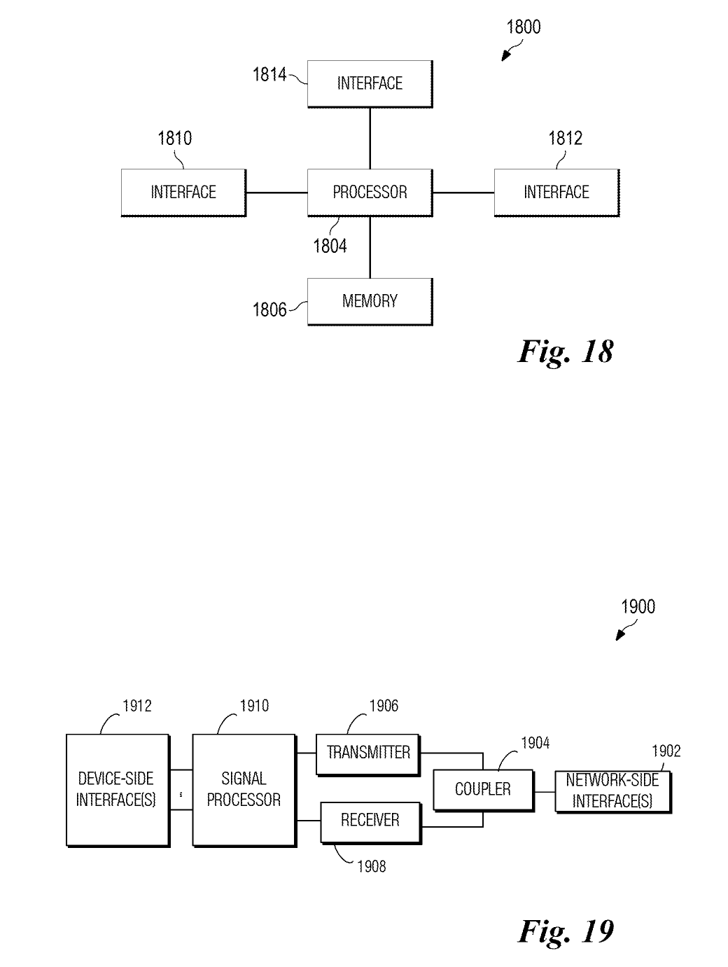

FIG. 18 illustrates a block diagram of an embodiment processing system 1800 for performing methods described herein, which may be installed in a host device. As shown, the processing system 1800 includes a processor 1804, a memory 1806, and interfaces 1810-1814, which may (or may not) be arranged as shown in FIG. 18. The processor 1804 may be any component or collection of components adapted to perform computations and/or other processing related tasks, and the memory 1806 may be any component or collection of components adapted to store programming and/or instructions for execution by the processor 1804. In an embodiment, the memory 1806 includes a non-transitory computer readable medium. The interfaces 1810, 1812, 1814 may be any component or collection of components that allow the processing system 1800 to communicate with other devices/components and/or a user. For example, one or more of the interfaces 1810, 1812, 1814 may be adapted to communicate data, control, or management messages from the processor 1804 to applications installed on the host device and/or a remote device. As another example, one or more of the interfaces 1810, 1812, 1814 may be adapted to allow a user or user device (e.g., personal computer (PC), etc.) to interact/communicate with the processing system 1800. The processing system 1800 may include additional components not depicted in FIG. 18, such as long term storage (e.g., non-volatile memory, etc.).

In some embodiments, the processing system 1800 is included in a network device that is accessing, or part otherwise of, a telecommunications network. In one example, the processing system 1800 is in a network-side device in a wireless or wireline telecommunications network, such as a base station, a relay station, a scheduler, a controller, a gateway, a router, an applications server, or any other device in the telecommunications network. In other embodiments, the processing system 1800 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 1810, 1812, 1814 connects the processing system 1800 to a transceiver adapted to transmit and receive signaling over the telecommunications network. FIG. 19 illustrates a block diagram of a transceiver 1900 adapted to transmit and receive signaling over a telecommunications network. The transceiver 1900 may be installed in a host device. As shown, the transceiver 1900 comprises a network-side interface 1902, a coupler 1904, a transmitter 1906, a receiver 1908, a signal processor 1910, and a device-side interface 1912. The network-side interface 1902 may include any component or collection of components adapted to transmit or receive signaling over a wireless or wireline telecommunications network. The coupler 1904 may include any component or collection of components adapted to facilitate bi-directional communication over the network-side interface 1902. The transmitter 1906 may include any component or collection of components (e.g., up-converter, power amplifier, etc.) adapted to convert a baseband signal into a modulated carrier signal suitable for transmission over the network-side interface 1902. The receiver 1908 may include any component or collection of components (e.g., down-converter, low noise amplifier, etc.) adapted to convert a carrier signal received over the network-side interface 1902 into a baseband signal. The signal processor 1910 may include any component or collection of components adapted to convert a baseband signal into a data signal suitable for communication over the device-side interface(s) 1912, or vice-versa. The device-side interface(s) 1912 may include any component or collection of components adapted to communicate data-signals between the signal processor 1910 and components within the host device (e.g., the processing system 1800, local area network (LAN) ports, etc.).

The transceiver 1900 may transmit and receive signaling over any type of communications medium. In some embodiments, the transceiver 1900 transmits and receives signaling over a wireless medium. For example, the transceiver 1900 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 1902 comprises one or more antenna/radiating elements. For example, the network-side interface 1902 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 1900 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

Although the present disclosure and its advantages have been described in detail, it should be understood that various changes, substitutions and alterations can be made herein without departing from the spirit and scope of the disclosure as defined by the appended claims.

1. A large scale multiple input multiple output (MIMO) communications device adapted to receive transmissions, the large scale MIMO communications device comprising:
a first plurality of antenna units (AUs) arranged in an array, wherein each AU in the first plurality of AUs is operatively coupled to at least two neighboring AUs over a wired communication pathway to transmit or receive MIMO transmission parameters, and wherein each AU is configured to receive wireless signals, to receive neighbor information from at least a first neighboring AU, to generate local information associated with the AU in accordance with the received wireless signals and the neighbor information, and to send the local information associated with the AU to a second neighboring AU; and
a central processing unit operatively coupled to a first end AU in the first plurality of AUs, the central processing unit configured to receive local information associated with the first end AU, and to generate estimates of the received transmissions in accordance with the local information associated with the first end AU.

2. The large scale MIMO communications device of claim 1, wherein the local information associated with the AU comprises a maximum ratio combining (MRC) vector associated with the AU and an autocorrelation matrix associated with the AU.

3. The large scale MIMO communications device of claim 1, wherein the first plurality of AUs is arranged in a mesh configuration.

4. The large scale MIMO communications device of claim 1, wherein the first plurality of AUs is arranged in a linear array configuration.

5. The large scale MIMO communications device of claim 1, wherein the first plurality of AUs is arranged in a tree configuration.

6. The large scale MIMO communications device of claim 1, further comprising a second plurality of AUs arranged in an array, and wherein the second plurality of AUs is operatively coupled to the first plurality of AUs.

7. The large scale MIMO communications device of claim 6, wherein the second plurality of AUs includes a second end AU, and wherein the second end AU is operatively coupled to the first end AU.

8. The large scale MIMO communications device of claim 6, wherein the first plurality of AUs and the central processing unit are co-located, and wherein the first plurality of AUs and the second plurality of AUs are geographically separated.

9. The large scale MIMO communications device of claim 1, wherein each AU comprises a receive antenna, a transmit antenna, and an AU processing unit operatively coupled to the receive antenna and to the transmit antenna.

10. A large scale multiple input multiple output (MIMO) communications device adapted to send transmissions, the large scale MIMO communications device comprising:
a central processing unit; and
a first plurality of antenna units (AUs) of a single device arranged in an array, wherein the first plurality of AUs is operatively coupled to the central processing unit, wherein each AU in the first plurality of AUs is operatively coupled to at least two neighboring AUs over a wired communication pathway, wherein each AU includes an AU processing unit, and wherein each AU is configured to receive local information associated with the AU from the central processing unit, and to generate data in accordance with the local information associated with the AU.

11. The large scale MIMO communications device of claim 10, wherein the local information associated with the AU comprises transmission data sent by the AU, and wherein the AU is configured to send the transmission data using a transmit antenna.

12. The large scale MIMO communications device of claim 10, wherein the local information associated with the AU comprises a reference signal associated with a transmission source, and wherein the data comprises a correlation between signals received by a receive antenna and the reference signal.

13. The large scale MIMO communications device of claim 10, further comprising a second plurality of AUs arranged in an array, and wherein the second plurality of AUs is operatively coupled to the first plurality of AUs.

14. The large scale MIMO communications device of claim 13, wherein the first plurality of AUs and the central processing unit are co-located, and wherein the first plurality of AUs and the second plurality of AUs are geographically separated.

15. The large scale MIMO communications device of claim 10, wherein each AU comprises a receive antenna, and a transmit antenna.

16-24. (canceled)

25. The large scale MIMO communications device of claim 10, wherein the local information associated with the AU comprises a maximum ratio combining (MRC) vector associated with the AU and an autocorrelation matrix associated with the AU.

26. The large scale MIMO communications device of claim 10, wherein the first plurality of AUs is arranged in a mesh configuration.

27. The large scale MIMO communications device of claim 10, wherein the first plurality of AUs is arranged in a linear array configuration.

28. The large scale MIMO communications device of claim 10, wherein the first plurality of AUs is arranged in a tree configuration.

29. The large scale MIMO communications device of claim 1, wherein the local information associated with the AU comprises transmission data sent by the AU, and wherein the AU is configured to send the transmission data using a transmit antenna.
